(19) United States
(12) Patent Application Publication
(10) Pub. No.: US 2008/0243997 A1
(43) Pub. Date: Oct. 2, 2008

(54) DISTRIBUTED CONTENT ITEM RECOMMENDATION SYSTEM AND METHOD OF OPERATION THEREFOR

(75) Inventors: Makram Bouzid, Palaiseau (FR); David Bonnefoy, Gilly sur Isere (FR); Nicolas Lhuillier, Versailles (FR); Kevin C. Mercer, Wantage (GB); Joon Young Park, Libertyville, IL (US); Jerome Picault, Paris (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/017,462

(22) Filed: Jan. 22, 2008

(30) Foreign Application Priority Data
Mar. 29, 2007 (GB) GB 0706143.5

(51) Int. Cl. G06F 15/16

(52) U.S. Cl. 709/203

(57) ABSTRACT

A distributed content item recommendation system comprises a central recommendation server (101) and a plurality of remote recommendation devices (103) coupled to the central recommendation server (101) via a communication network (105). The central recommendation server (101) stores content item set correlation data for sets of content items. The correlation data is used for item based collaborative filtering in recommendation processors (303) of the recommendation devices (103). A computation task processor (207) maintains a task list of content item correlation computation tasks which can be independently executed to generate content item set correlation data. A task assignment processor (209) can assign the computation tasks to remote recommendation devices (103) which comprise a processing unit (307) that calculates the associated correlation data and returns it to the recommendation server (101). The distributed recommendation system thus uses distributed computation of centrally stored correlation data thereby substantially reducing the cost and complexity of the recommendation server and/or improves the recommendations.

### FIELD OF THE INVENTION

The invention relates to a distributed content item recommendation system and method of operation therefor and in particular, but not exclusively, to a recommendation system for recommending content items such as articles, television programmes, music etc.

### BACKGROUND OF THE INVENTION

In recent years, the availability and provision of information and entertainment content has increased substantially. For example, the number of online news and entertainment articles available to the average user has grown considerably e.g. with the increased popularity of the Internet. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content, personalizing services etc. Specifically, recommendation systems have been developed which can automatically search through vast amounts of content and select specific content to be recommended to the individual user.

In order to enhance the user experience, it is advantageous to personalise the recommendations to the individual user as much as is possible. In this context, a recommendation can be considered to consist in predicting how much a user may like a particular content item and recommending it if it is considered of sufficient interest. The process of generating recommendations requires that user preferences have been captured so that they can be used as input data by the prediction algorithm.

Furthermore, people increasingly use a wide range of electronic devices for different purposes and with different capabilities (e.g. cell phone, PDA, MP3 players, set-top boxes, personal computers, etc.) All these devices are running more and more complex applications with many applications using some element of personalisation to provide a better or simplified user experience.

Personalisation technology usually involves a user profile which collects user preferences and a prediction algorithm which uses the preferences to infer suitable personalisation actions. However, as personalisation methods are used by different devices for different purposes, these tend not to provide a consistent and harmonised personalised user experience.

In order to provide a harmonised user experience for a plurality of user devices it has been proposed to use a centralised recommendation engine or a single centralised user profile that may be accessed by a plurality of prediction algorithms operating on individual devices. However, such approaches tend to have a number of disadvantages and tend to be complex, cumbersome, inflexible, have poor updating capabilities and to provide sub-optimal recommendations. Therefore, it is in many cases advantageous to perform the recommendation operation locally at the individual device.

Recommendation systems have been proposed which use collaborative filtering techniques. The basic object of collaborative filtering is to provide predictions or recommendations based on the opinions of other like-minded users. A collaborative filtering system generally relies on a large amount of user preference information relating to a large group of users and typically uses a similarity analysis algorithm to identify similar users (user based collaborative filtering) or content items (item based collaborative filtering). The similarity analysis is then used to generate a subgroup of users/ content items with ratings similar to the user/content item for which the recommendation is generated. In this way a recommendation can be generated based on the combined preferences from the subgroup of users/items.

It is known to design collaborative filtering systems based on a client-server architecture where the components of the collaborative filtering system are distributed between the clients and the server. For example, the clients may be the users' personal devices (personal computer, set-top box, mobile phone, etc.) and the server may be hosted by a content or recommendation provider. In such systems, the collection of user preference ratings and the similarity evaluation is typically performed by the central server whereas the actual user preference rating generation and recommendation analysis is performed by the individual device.

Specifically, for item based collaborative filtering similarity values, known as correlations, between content items are calculated at the central server based on user preference ratings received from the users. The resulting correlations are stored at the central server and a requesting user device may be provided with specific correlation data required to generate a recommendation.

However, as typical content recommendation systems process a large number of content items, the computational resource of the central recommendation server must be very high leading to very high complexity and cost and/or long computation times which may prevent real time applications. For example, systems are known where the recommendations are based on a correlation matrix comprising correlations between any two content item pairs which result in a very high computational requirement even for moderate numbers of content items. Accordingly, the central recommendation servers tend to be large, complex and expensive and to limit the number of content items that can be processed.

Hence, an improved distributed content item recommendation system would be advantageous and in particular a system allowing increased flexibility, reduced complexity of central recommendation servers, reduced cost of central recommendation servers, reduced computational demand on the central recommendation servers, improved recommendations and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a distributed content item recommendation system comprising a central recommendation server and a plurality of remote recommendation devices coupled to the central recommendation server via a communication network; wherein: the central recommendation server comprises: a correlation data store for storing content item set correlation data for sets of content items, means for providing content item set correlation data to the remote recommendation devices, means for maintaining a task list of content item correlation computation tasks, each content item correlation computation task determining content item set correlation data for at least one set of content items and each content item correlation computation task being computable independently of other content item correlation computation tasks, assigning means for assigning content item correlation computation tasks from the task list to remote recommendation devices, means for receiving first content item set correlation data for a first set of content items from a remote recommendation device assigned a content item correlation computation tasks for the first set, and means for including the first content item set correlation data in the correlation data store; and the remote recommendation devices comprise: means for receiving content item set correlation data from the central recommendation server; recommendation means for generating a content item recommendation in response to the content item set correlation data; processing means for executing an assigned content item correlation computation task to generate associated content item set correlation data; and means for transmitting the associated content item set correlation data to the central recommendation server.

The invention may provide an improved distributed content item recommendation system and may in particular reduce the computational requirement for the central recommendation server of such a system. In many embodiments, the invention may reduce the total required computational resource by utilising otherwise unused computational resource.

The invention may increase the number of content items and correlations that can be used for generating recommendations and may provide improved recommendations for a given complexity and cost of the central recommendation server. In particular, the invention may in many embodiments enable or facilitate the generation of real time recommendations.

The invention may provide an integrated environment wherein available computational resource is reused to provide correlation data. In particular, the recommendation operation and generation of correlation data may be managed in an integrated way thereby more fully exploiting the available resource in the system. Specifically, in many embodiments the integration of the correlation generation and the recommendation may allow an autonomous adaptation of the operation of the system to the current conditions.

According to another aspect of the invention there is provided a central recommendation server for a distributed content item recommendation system further including a plurality of remote recommendation devices coupled to the central recommendation server via a communication network; the central recommendation server comprising: a correlation data store for storing content item set correlation data for sets of content items; means for providing content item set correlation data to the remote recommendation devices; means for maintaining a task list of content item correlation computation tasks, each content item correlation computation task determining content item set correlation data for at least one set of content items and each content item correlation computation task being computable independently of other content item correlation computation tasks; means for assigning content item correlation computation tasks from the task list to remote recommendation devices; means for receiving first content item set correlation data for a first set of content items from a remote recommendation device assigned a content item correlation computation task for the first set; and means for including the first content item set correlation data in the correlation data store.

According to another aspect of the invention there is provided a method of operation for a distributed content item recommendation system comprising a central recommendation server and a plurality of remote recommendation devices coupled to the central recommendation server via a communication network; the method comprising: the central recommendation server performing the steps of: storing content item set correlation data for sets of content items in a correlation data store, providing content item set correlation data to the remote recommendation devices, maintaining a task list of content item correlation computation tasks, each content item correlation computation task determining content item set correlation data for at least one set of content items and each content item correlation computation task being computable independently of other content item correlation computation tasks, assigning content item correlation computation tasks from the task list to remote recommendation devices, receiving first content item set correlation data for a first set of content items from a remote recommendation device assigned a content item correlation computation task for the first set, and including the first content item set correlation data in the correlation data store; and the remote recommendation device performs the steps of: receiving content item set correlation data from the central recommendation server, generating a content item recommendation in response to the content item set correlation data, executing an assigned content item correlation computation task to generate associated content item set correlation data, and transmitting the associated content item set correlation data to the central recommendation server.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a distributed content item recommendation system in accordance with some embodiments of the invention;

FIG. 2 illustrates an example of a recommendation server in accordance with some embodiments of the invention;

FIG. 3 illustrates an example of a recommendation device in accordance with some embodiments of the invention;

FIG. 4 illustrates an example of a method of operation for a recommendation server in accordance with some embodiments of the invention; and

FIG. 5 illustrates an example of a method of operation for a recommendation device in accordance with some embodiments of the invention.

### DETAILED DESCRIPTION OF SOME EMBODIMENTS OF THE INVENTION

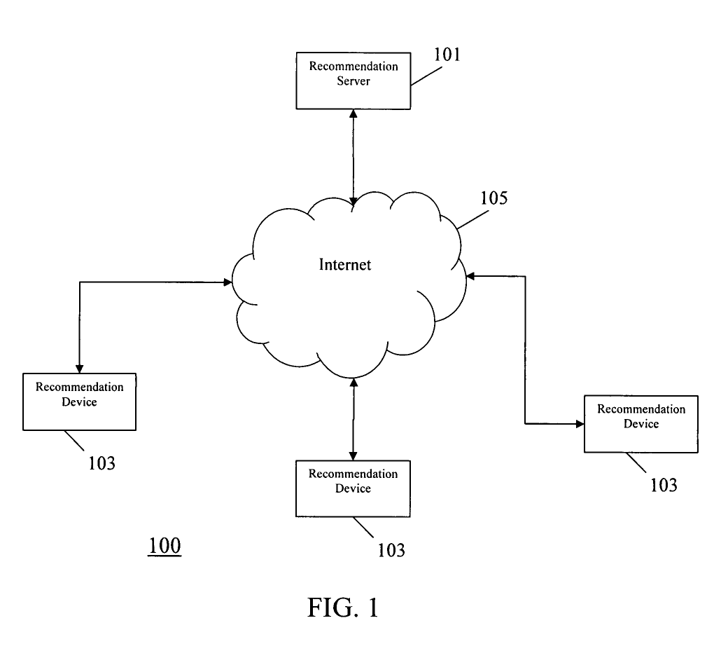

FIG. 1 illustrates an example of a distributed content item recommendation system supported by the Internet. The system comprises a central recommendation server 101 which supports a plurality of remote recommendation devices 103 coupled to the central recommendation server 101 via a communication system/network which in the specific example is the Internet 105. The remote recommendation devices 103 may for example include personal consumer devices including for example cell phones, personal digital assistants, set-top boxes, personal computers, etc.

In the system, item based collaborative filtering is used by the remote recommendation devices 103 to filter a number of content items in order to select a subset to recommend to a user. Depending on the specific embodiment, a content item may for example be a television programme, a document, an indication of a service, a radio programme etc.

The collaborative filtering algorithm uses correlations between different users' ratings of different content items to select content items to recommend to the user. For example, a correlation may reflect how the ratings provided by a large group of users compare for two specific items. E.g. if a large number of users have provided very similar ratings for a first and a second content item, the correlation will indicate that the first and second content item are very similar/highly correlated. In contrast, if most users having rated both content items provide very different ratings for the two content items, the correlation will indicate that the first and second content item are not similar/have a low correlation. The correlations are then used by recommendation algorithms to generate recommendations for a user. For example, if a user has rated the first content item highly, a strong correlation will indicate that the user also has a high preference for the second content item whereas a low correlation may indicate that the user has a low preference for the second content item. In the former case, the second content item is likely to be recommended to the user whereas it is likely to be discarded in the latter case.

It will be appreciated that different and more complex correlation algorithms based on item to item correlation data will be known to the skilled person and may be used without detracting from the invention.

In systems where a large number of content items are processed, an efficient design of the storage, distribution and calculation functionality is critical in order to achieve an efficient implementation. For example, many systems use a correlation matrix wherein correlations between pairs of content items are stored and used in the collaborative filtering. However, the number of correlations increases with the square of the number of content items thereby resulting in very high storage, distribution and computational requirements even for moderate numbers of content items.

In the system of FIG. 1, the recommendation functionality is distributed such that each individual recommendation device 103 comprises a recommendation engine for performing the actual correlation filtering. Thus, the actual recommendation generation may be performed locally by the individual recommendation device 103 thereby facilitating operation, facilitating customisation to the specific device/user and reducing the computational resource requirement for the recommendation server 101.

However, the correlation data is stored centrally at the recommendation server 101 thereby avoiding the requirement for all correlation data to be distributed to and stored by each individual recommendation device 103. The individual recommendation devices 103 can request the required correlation data from the recommendation server 101. The recommendation server 101 then retrieves the requested data and transmits it to the recommendation device 103 where it is used to perform the collaborative filtering.

The correlation data is computed on the basis of user ratings received at the recommendation server 101 from the recommendation devices 103. As the number of content items increase, the computational resource required for this computation becomes critical and may substantially increase the complexity and cost of the recommendation server 101.

However, the system of FIG. 1 implements a distributed computation of the correlation data and uses the recommendation devices 103 (optionally in addition to the recommendation server 101) for this computation. In the system, the correlation data is still centrally stored and managed by the recommendation server 101 but at least some correlation data is calculated by the remote recommendation devices 103.

In the example, the recommendation server 101 maintains a shared repository of correlation data computation tasks. The individual tasks are independent and reflect the different item correlations that are to be computed. A recommendation device 103 may be assigned a computation task and may accordingly use its computational resource to generate the correlation results which are then sent back to the recommendation server 101 where it is stored.

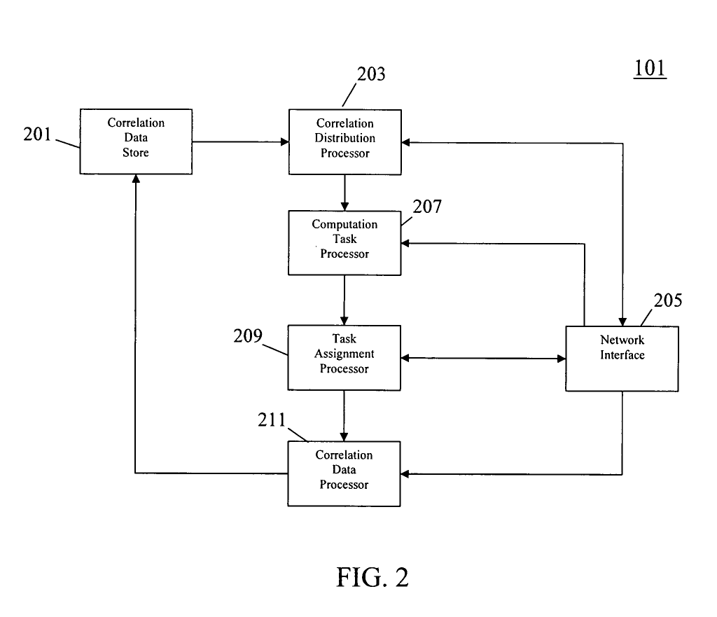

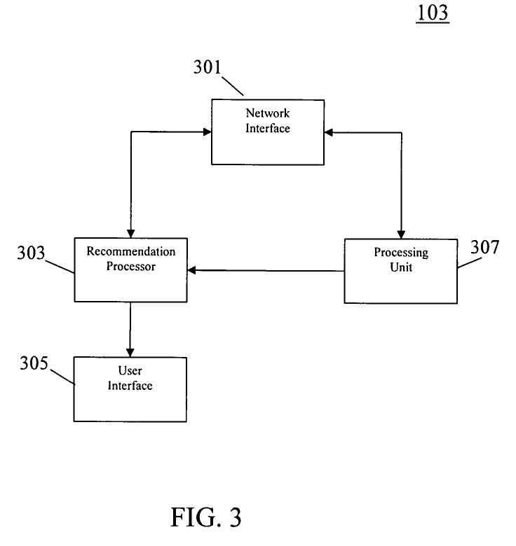

The system will be described in more detail in the following with reference to FIG. 2 which shows an example of elements of the recommendation server 101 and FIG. 3 which shows an example of elements of a recommendation device 103.

The recommendation server 101 comprises a correlation data store 201 wherein the correlation data is stored. Specifically, the correlation data store 201 comprises a correlation matrix with an entry for each possible content item pair, e.g. for each pair of television programmes being transmitted within a given time interval. In any given time, this matrix will typically be partly populated with correlation data. Thus correlation data will be available for some content item pairs but not for other pairs.

It will be appreciated that in other embodiments other groupings may be used and for example sets of 3, 4 or more content items may be associated with a single correlation value.

The recommendation server 101 furthermore comprises a correlation distribution processor 203 coupled to the correlation data store 201 and a network interface 205 which interfaces the recommendation server 101 to the Internet 105.

The correlation distribution processor 203 may receive requests for correlation data for specific content item pairs from the recommendation device 103 via the Internet 105. In response, the correlation distribution processor 203 retrieves the requested data and transmits it to the requesting recommendation device 103.

The recommendation device 103 comprises a network interface 301 which interfaces the recommendation device 103 to the Internet 105. The network interface 301 is coupled to a recommendation processor 303 which is coupled to a user interface 305. The recommendation processor 303 is arranged to perform a collaborative filtering based on content item to content item correlation data received from the recommendation server 101.

It will be appreciated that different algorithms for item based collaborative filtering will be known to the skilled person and that any suitable algorithm may be used without detracting from the current invention.

Based on the collaborative filtering, the recommendation processor 303 can recommend one much more content items to the user. For example, the recommendation processor 303 can identify a number of television programmes considered to be of particular interest to the user of the recommendation device can be fed to the user interface 305 in order to be presented to the user.

The recommendation processor 303 first identifies the content item pairs for which the correlation data is needed in order to perform the collaborative filtering. It then determines if this data is available locally in the recommendation device 103 (for example if it was downloaded for a previous collaborative filtering process). If not, it generates a data request message which is transmitted to the recommendation server 101 using the network interface 301. When the requested data is received from the recommendation server 101 it proceeds to perform the filtering process to generate the content item recommendations.

For example, the recommendation device 103 may be provided with a default set of content items which needs to be filtered in order to provide specific recommendations to the user (e.g. it may receive a list of the television programmes which are being broadcast the following week). In addition it may have stored a number of content items which have previously been rated by the user (e.g. the television programmes broadcast the previous and/or current week). The recommendation processor 303 can then identify all the content item pairs comprising one content item from the group to be filtered and one content item already rated. It can then proceed to request correlation data for all the correlation pairs for which it does not already have correlation data. The request is transmitted to the recommendation server 101 and fed to the correlation distribution processor 203 which proceeds to retrieve the requested correlation data from the correlation data store 201. The retrieved correlation data is then transmitted back to the recommendation device 103.

However, as the correlation data matrix is only partly populated, it may not be possible to retrieve all the requested data. Thus, for the content item pairs for which it does not have correlation data the recommendation server 101 may return an indication that this data is not available. The recommendation processor 303 may then in some scenarios proceed with the collaborative filtering by ignoring this data. Alternatively, it may wait for this data to be available or may itself initiate a computation of this correlation data as will be described later.

Thus, when a recommendation device 103 transmits a request for requested content item set correlation data to the central recommendation server 101, the correlation distribution processor 203 proceeds to evaluate if correlation data which meets a suitable validity criterion is stored in the correlation data store 201. As a simple example, the validity criterion may simply be that the correlation data store 201 comprises correlation data for the identified content item pairs, i.e. that a correlation data computation has previously been performed for this content item pair. However, in other embodiments more complex validity criteria may be used, such as a requirement that the requested correlation data has been computed within a given time interval. If correlation data meeting the criterion is available, it is transmitted to the recommendation device 103 to be used for the collaborative filtering.

In the example, the calculations of the correlation data for different content item pairs are at least partly performed by the remote recommendation devices 103. Accordingly, the recommendation server 101 comprises a computation task processor 207 which is coupled to the correlation distribution processor 203 and is operable to maintain a task list comprising content item correlation computation tasks which should preferably be performed. Thus, the computation task processor 207 may keep tracks of content item pairs for which a computation of correlation data is required. For example, in an embodiment with a relatively small correlation data matrix, the computation task processor 207 can continuously monitor all entries to evaluate whether valid correlation data has been calculated within a given time interval. Whenever a content item pair is identified for which the correlation data has not been calculated within the specified time interval, the computation task processor 207 can define a new correlation data computation task for that content item pair. The computation task may for example be defined by an indication of the two content items, received user rating data for the two content items as well as the indication of the preferred correlation algorithm to be used to determine the correlation data value.

The content item correlation computation tasks are thus represented by an indication of the desired computation algorithm as well as the input data required by the algorithm. Thus, each of the content item correlation computation tasks can comprise all information required for the computation of the correlation data value and is thus computable independently of other content item correlation computation tasks.

In the example, the item-to-item correlation data reflects how closely correlated user ratings for a pair of content items are. In the system of FIG. 1, user ratings may frequently be transmitted to the central recommendation server 101 from the recommendation devices 103. For example, every time a user inputs a user rating for a content item, a user rating feedback message is generated by the recommendation device 103 and transmitted back to the recommendation server 101. The user rating message is received by the computation task processor 207 and is included in any correlation data computation task involving the content item for which the user rating is provided.

Specifically, for two content items which have both been rated by a number of users, the correlation can be computed using, for instance, the Pearson product-moment correlation coefficient as will be known to the person skilled in the art. Thus, a correlation data computation task for these content items can simply include the received rating pars for the two content items {R₁; R₂} (where R₁ is the rating for the first item and R₂ is the rating for the second item) and, optionally, the correlation algorithm to be used.

Thus, in the specific example the content item correlation computation tasks are defined by a set of content item ratings and an optional indication of the correlation algorithm to be used by the recommendation devices 103 to determine the content item set correlation data.

The computation task processor 207 is coupled to a task assignment processor 209 which is further coupled to the network interface 205. The task assignment processor 209 is arranged to assign content item correlation computation tasks from the task list to remote recommendation devices 103. For example, the task assignment processor 209 may in a simple embodiment randomly and uniformly assign individual correlation data computation tasks to individual recommendation devices 103.

When a task is assigned to a specific recommendation device 103 the task assignment processor 209 transmits a task assignment message to the recommendation device 103 via the network interface 205. The task assignment message comprises data defining the computation task to be performed. Specifically, the task assignment message can comprise data representing the content item pair, user ratings received for the content item pair as well as an indication of the correlation algorithm to use.

The recommendation device 103 comprises a processing unit 307 coupled to the network interface 301. When an assignment command is received by the recommendation device 103 this is fed to the processing unit 307. The processing unit 307 may then execute the assigned content item correlation computation task to generate the associated content item set correlation data.

Typically the processing unit 307 and the recommendation processor 303 (as well as other functionality of the recommendation device) may use the same shared computational resource of the recommendation device 103. For example, the recommendation processor 303 and processing unit 307 may be implemented by the same digital signal processor or microcontroller. In such embodiments, the generation of recommendations (and potentially other functionality) will typically take priority over the correlation data computation task. Thus, the recommendation device 103 may wait until sufficient computational resource is not used by other functionality and may then proceed to calculate the correlation data.

Typically, the computational demand for a typical user device exhibits large variations with time. Furthermore, most of the time, the full computational resource is not used. Also, the computational demand of each individual correlation data compensation task is typically relatively limited. The delay before a computation task is performed therefore tends to be relatively small.

When the correlation data computing task has been executed, the processing unit 307 transmits the associated content item set correlation data back to the central recommendation server 101 in a suitable result message. Specifically the result message is transmitted via the Internet 105 using the network interface 301.

The recommendation server 101 furthermore comprises a correlation data processor 211 coupled to the task assignment processor 209, the network interface 205 and the correlation data store 201. When the result message is received this is fed to the correlation data processor 211 by the network interface 205. The correlation data processor 211 then stores the received correlation data for the content item in the correlation data store 201 by entering it at the appropriate memory location for the entry in the correlation data matrix of the specific content item pair.

Thus, the approach allows correlation data to be calculated without using computational resource of the recommendation server 101 itself. Furthermore, as a typical recommendation system will comprise a large number of typically underused recommendation devices 103, the approach may efficiently exploit a vast amount of otherwise unused computational resource thereby allowing computation of much larger correlation data matrices. Thus, in addition to a substantially reduced cost and complexity of the central server, the approach may alternatively or additionally provide improved recommendations thereby providing an improved user experience.

Furthermore, the system provides an efficient distribution of data and functionality in a recommendation system. In particular, it allows distributed recommendation operations to be performed based on item based collaborative filtering by providing a centralised source of the collaborative data required for the recommendations. Furthermore, despite a distributed calculation of correlation data, the recommendation functionality is not further complicated but can use the same basic approach and in particular can obtain the required information from a single source. Thus, data distribution is effectively managed.

Also, by centrally storing and managing only the correlation data, the computational processing required to generate the data can be broken down into separate and independent computing tasks of relatively low complexity and resource requirement thereby enabling an efficient distribution of the task of generating the data required for item based collaborative filtering to individual recommendation devices with relatively low individual computational capacity.

Also, the system allows a dynamic and automatic adaptation of the processing to the current conditions and in particular allows the computational resource usage for the generation of correlation data to adapt to the available instantaneous computational resource availability.

It will be appreciated that different criteria for determining when to generate new correlation data computation tasks may be used in different embodiments. For example, in the previous example, a computation task is generated whenever the computation task processor 207 detects that valid correlation data does not exist for a specific content item pair. The computation task processor 207 may use an obsolescence criterion to determine whether the stored data is valid. For example, when correlation data is computed and entered into the correlation data store 201 it can be associated with an expiry time after which the data is no longer considered to be valid. Thus, in this example the computation task processor 207 may generate a new computation task whenever it detects that the stored correlation data for giving content item pair has expired.

In other embodiments, the correlation matrix may be so large that it is not practical for the computation task processor 207 to continuously monitor all possible content item pairs. In such a case, computation tasks may be generated in response to a dynamic detection of a requirement from the recommendation devices 103. For example, the computation task processor 207 may generate a new content item correlation computation task to be included in the task list if a request is received for correlation data which does not meet the validity criterion—for example if the stored correlation data has expired.

Thus, whenever a request is received from a recommendation device 103 for correlation data for a specific content item pair, the correlation distribution processor 203 retrieves this data from the correlation data store 201 and evaluates the validity criterion. If the retrieved data does not meet the validity criterion—e.g. if no previous correlation data has been computed or if the stored correlation data has expired—a new computation task is generated and included in the list of pending computation tasks. The new computation task is defined by the content items for which the correlation data should be calculated as well as the user ratings received for these content items. The user ratings may for example be limited to user ratings received within a given time interval and may include both user ratings which have previously been used to calculate correlation data as well as user ratings received since the last calculation of correlation data.

Additionally or alternatively, a new content item correlation computation task can be generated in response to content item ratings being received. For example, whenever a new user rating is received this is fed to the computation task processor 207 which temporarily stores these. When the computation task processor 207 has received a given number of user ratings for a specific content item pair it may proceed to generate a new correlation data computation task in order to update a previous calculation to take the new ratings into account. Thus, when a sufficient amount of new data is available, the computation task processor 207 inserts the associated task in the task list. Such an approach will ensure that the stored correlation data is continuously updated to reflect all received user rating information.

As another example, received user ratings may be compared to stored correlation data and if a deviation above a given threshold is detected, a new computation task may be defined. The comparison may be performed infrequently and for only a small subset of the received user ratings in order not to substantially increase the computational resource use.

It will be appreciated that any suitable algorithm or criterion for assigning computation task to the individual recommendation devices 103 may be used.

In some cases, a computation task may be assigned depending on the cause of the task being created in the first place. Specifically, when a computation task is generated because a recommendation device 103 requests correlation data which does not exist, the computation task itself may be assigned to the requesting recommendation device 103. For example, the requesting recommendation device 103 may include an indication in the correlation data request which reflects that the recommendation device 103 has available computational resource that can be used to calculate correlation data. As the recommendation device 103 is currently generating a recommendation using the missing correlation data, it can be advantageous that the computation task is immediately assigned to the requesting recommendation device 103 such that it can use the computer correlation data in the current filtering process. Thus, the processing unit 307 of the requesting recommendation device 103 may upon completion of the assigned task feed the resulting correlation data directly to the recommendation processor 303 for use in the collaborative filtering performed to generate a recommendation. In addition, the processing unit 307 transmits the correlation data result to the recommendation server 101 which stores it in the correlation data store 201.

In some embodiments, the recommendation devices 103 may furthermore continuously evaluate whether all of the computational resource of the recommendation device is used or whether there is available computational resource that can be used for calculation of correlation data. Specifically, if the recommendation device 103 is in an idle mode resulting in there being unused computational resource (e.g. because no recommendations are currently being generated and/or because the device is switched to a standby mode), it may proceed to request the assignment of a computation task. Specifically it can transmit an assignment request message to the recommendation server 101 in response to which the task assignment processor 209 may proceed to assign a task to the requesting recommendation device 103. Thus, the system may allow the typically vast amount of unused computational resource in a recommendation system to be actively used thereby substantially reducing the cost of the central recommendation server 101 and/or increasing the number of content items that can be considered when performing collaborative filtering.

In some embodiments, the central recommendation server 101 is furthermore arranged to calculate correlation data. Specifically, the central recommendation server 101 may comprise functionality which determines whether there is any unused available computational resource in the central recommendation server 101. If so, the central recommendation server 101 may request that one or more correlation data computation tasks are assigned to it. It may then proceed to execute any assigned computation task in order to generate correlation data. This correlation data is then fed to the correlation data processor 211 which stores it in the correlation data store 201. Any unused computational resource in the central recommendation server 101 may thus be utilised to support the recommendation operations. Furthermore, the management and consideration of the computational resource of the recommendation server 101 may be managed and used in exactly the same way as the computational resource of the recommendation devices 103 thereby facilitating operation and reducing complexity.

It will be appreciated by the skilled person that any suitable algorithm for assigning and distributing computing tasks in a distributed computational system may be used. For example, the task assignment processor 209 may use Distributed Hash-Table techniques to manage and assign computational tasks to the different recommendation devices 103.

In the specific example of FIG. 1, the central recommendation server 101 can respond in three different ways when a correlation data request is received from a recommendation device 103.

Firstly, if valid requested correlation data is available from the correlation data stored 201 this data is returned to the requesting recommendation device 103 in a suitable message.

Secondly, if the requested correlation data is either not available or obsolete, the central recommendation server 101 may return a message indicating that this information is not available and requesting the recommendation device 103 to compute the missing data. Thus, this message will comprise an indication of a computation task which is generated in response to the request. Thus task will thus automatically be assigned to the requesting recommendation device 103. In response, the recommendation device 103 proceeds to calculate the correlation data and transmit this back to the recommendation server 101 or it may reject the assignment by returning a message indicating that the correlation data will not be calculated.

Thirdly, if the requested correlation data is either not available or obsolete but the task assignment processor 209 decides not to assign it to the requesting recommendation device 103, the recommendation server 101 returns a message indicating that this information is currently not available. Specifically, if a computation task is currently assigned to another recommendation device which has not yet provided the correlation data, a wait indication is transmitted which indicates that this information is not currently available but is expected to be available soon. The computation task may for example have been assigned previously or may be assigned to another recommendation device or the central recommendation server 101 itself following the receipt of the request from the recommendation device 103.

In some embodiments, the calculated correlation data is time stamped such that it is associated with the time of the computation. This time stamping may be performed by the recommendation devices 103 or may e.g. be performed by the correlation data processor 211 when the correlation data is received from the recommendation devices 103.

The time stamp may be used to determine whether the correlation data has expired when it is requested by recommendation device 103 at a later point in time. Thus, the correlation data validity criterion may include a comparison of the time of the correlation data computation and the time of its use. If the time difference exceeds a certain threshold, the correlation data is considered to be obsolete.

The previous description focused on embodiments wherein the correlation data was provided to the recommendation devices 103 in response to a specific request from these. However, in other embodiments, the correlation data may alternatively or additionally be transmitted to all or some of the recommendation devices without these requesting the data. For example, when new correlation data is received from a recommendation device 103, a correlation data message comprising this data may be transmitted to all recommendation devices 103 which have previously requested corresponding correlation data. Thus, the recommendation server 101 may proactively push newly computed correlations to the recommendation devices 103 such that these are used for new item recommendations. This may ensure that the newest correlation data is used by the recommendation devices 103 when performing the collaborative filtering.

In some embodiments, the recommendation devices may furthermore be arranged to generate the correlation data by a distributed computation between a number of remote recommendation devices 103 coupled together e.g. via the Internet or another network connection. For example, the recommendation devices 103 may support a personal ad hoc network including all recommendation devices 103 belonging to a specific user. The correlation computation data may in such examples be distributed across the recommendation devices 103 of the personal network. For example, if the user has a set-top box connected to his/her personal computer (PC) and personal digital assistant (PDA), the computation tasks corresponding to e.g. TV programme correlations being received by the set-top box could be distributed between the PC and the PDA, if they are in idle mode.

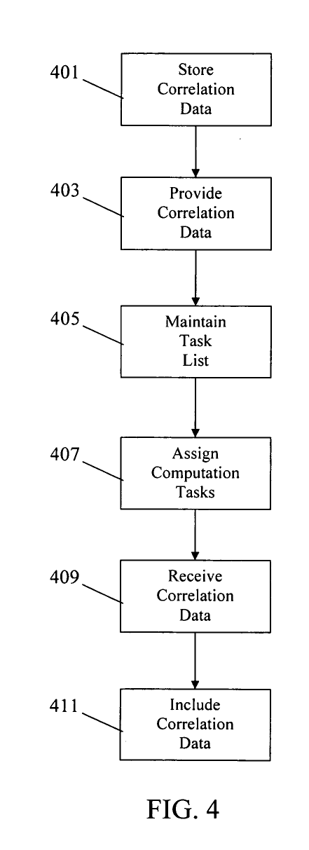

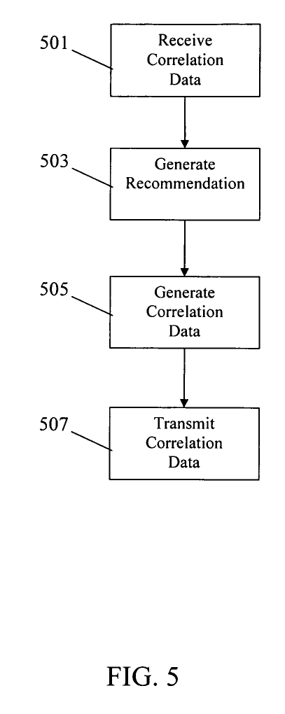

FIG. 4 illustrates an example of a method of operation for the central recommendation server 101 of FIG. 1 and FIG. 5 illustrates an example of a method of operation for a recommendation device 103 of FIG. 1.

The method of operation for the central recommendation server 101 initiates in step 401 wherein content item set correlation data for sets of content items is stored.

Step 401 is followed by step 403 wherein content item set correlation data is provided to the remote recommendation devices.

Step 403 is followed by step 405 wherein a task list of content item correlation computation tasks is maintained. Each content item correlation computation task determines content item set correlation data for at least one set of content items and each content item correlation computation task is computable independently of other content item correlation computation tasks.

Step 405 is followed by step 407 wherein content item correlation computation tasks from the task list are assigned to remote recommendation device.

Step 407 is followed by step 409 wherein first content item set correlation data is received for a first set of content items from a remote recommendation device assigned a content item correlation computation tasks for the first set.

Step 409 is followed by step 411 wherein the first content item set correlation data is included in the correlation data store.

The method of operation for the recommendation device 103 initiates in step 501 wherein content item set correlation data is received from the central recommendation server.

Step 501 is followed by step 503 wherein a content item recommendation is generated in response to the content item set correlation data.

Step 503 is followed by step 505 wherein an assigned content item correlation computation task is executed to generate associated content item set correlation data.

Step 505 is followed by step 507 wherein the associated content item set correlation data is transmitted to the central recommendation server.

It will be appreciated FIGS. 4 and 5 illustrates specific exemplary scenarios and that the method steps need not be in the described order and need not be performed sequentially.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A distributed content item recommendation system comprising a central recommendation server and a plurality of remote recommendation devices coupled to the central recommendation server via a communication network; wherein:
the central recommendation server comprises:
a correlation data store for storing content item set correlation data for sets of content items,
means for providing content item set correlation data to the remote recommendation devices,
means for maintaining a task list of content item correlation computation tasks, each content item correlation computation task determining content item set correlation data for at least one set of content items and each content item correlation computation task being computable independently of other content item correlation computation tasks,
assigning means for assigning content item correlation computation tasks from the task list to remote recommendation devices,
means for receiving first content item set correlation data for a first set of content items from a remote recommendation device assigned a content item correlation computation tasks for the first set, and
means for including the first content item set correlation data in the correlation data store; and
the remote recommendation devices comprise:
means for receiving content item set correlation data from the central recommendation server;
recommendation means for generating a content item recommendation in response to the content item set correlation data;
processing means for executing an assigned content item correlation computation task to generate associated content item set correlation data; and
means for transmitting the associated content item set correlation data to the central recommendation server.

2. The distributed content item recommendation system of claim 1 wherein the content item set correlation data depends on content item ratings and the central recommendation server is arranged to receive content item ratings from the remote recommendation devices.

3. The distributed content item recommendation system of claim 1 wherein the central recommendation server comprises means for generating a content item correlation computation task for the task list in response to the content item ratings.

4. The distributed content item recommendation system of claim 1 wherein at least a first of the remote recommendation devices comprises means for transmitting a request for requested content item set correlation data to the central recommendation server; and the central recommendation server comprises means for transmitting the requested content item set correlation data to the first remote recommendation device if the requested content item set correlation data meets a validity criterion; and the recommendation means of the first remote recommendation device is arranged to generate a recommendation in response to the requested content item set correlation data.

5. The distributed content item recommendation system of claim 4 wherein the validity criterion comprises a comparison of a request time with an expiry time of the requested content item set correlation data.

6. The distributed content item recommendation system of claim 5 wherein the remote recommendation devices comprise means for time stamping associated content item set correlation data transmitted to the central recommendation server.

7. The distributed content item recommendation system of claim 4 wherein the central recommendation server comprises means for generating a first content item correlation computation task for the task list if the requested content item set correlation data does not meet the validity criterion.

8. The distributed content item recommendation system of claim 7 wherein the assigning means is arranged to assign the first content item correlation computation task to the first remote recommendation device.

9. The distributed content item recommendation system of claim 4 wherein the central recommendation server comprises means for transmitting a wait indication to the first remote recommendation device in response to a determination that a content item correlation computation task for the requested content item set correlation data is currently assigned.

10. The distributed content item recommendation system of claim 1 wherein the content item correlation computation tasks are at least partly represented by a set of content item ratings.

11. The distributed content item recommendation system of claim 1 wherein the content item correlation computation tasks are at least partly represented by an indication of a correlation algorithm to be used for determining the content item set correlation data.

12. The distributed content item recommendation system of claim 1 wherein the remote recommendation devices comprise means for requesting an assignment of a content item correlation computation task in response to a determination of an available computational resource of the remote recommendation device.

13. The distributed content item recommendation system of claim 1 wherein the central recommendation server comprises means for executing an assigned content item correlation computation task to generate associated content item set correlation data; and means for requesting an assignment of a content item correlation computation task in response to a determination of an available computational resource of the central recommendation server.

14. The distributed content item recommendation system of claim 1 wherein the central recommendation server comprises means for transmitting unrequested content item set correlation data to remote recommendation devices in response to receiving the unrequested content item set correlation data from an assigned content item correlation computation task.

15. The distributed content item recommendation system of claim 1 further comprising means for performing a distributed execution of a content item correlation computation task between the processing means of a plurality of remote recommendation devices.

16. A central recommendation server for a distributed content item recommendation system further including a plurality of remote recommendation devices coupled to the central recommendation server via a communication network;
the central recommendation server comprising:
a correlation data store for storing content item set correlation data for sets of content items;
means for providing content item set correlation data to the remote recommendation devices;
means for maintaining a task list of content item correlation computation tasks, each content item correlation computation task determining content item set correlation data for at least one set of content items and each content item correlation computation task being computable independently of other content item correlation computation tasks;
means for assigning content item correlation computation tasks from the task list to remote recommendation devices;
means for receiving first content item set correlation data for a first set of content items from a remote recommendation device assigned a content item correlation computation task for the first set; and
means for including the first content item set correlation data in the correlation data store.

17. A method of operation for a distributed content item recommendation system comprising a central recommendation server and a plurality of remote recommendation devices coupled to the central recommendation server via a communication network;
the method comprising:
the central recommendation server performing the steps of:
storing content item set correlation data for sets of content items in a correlation data store,
providing content item set correlation data to the remote recommendation devices,
maintaining a task list of content item correlation computation tasks, each content item correlation computation task determining content item set correlation data for at least one set of content items and each content item correlation computation task being computable independently of other content item correlation computation tasks,
assigning content item correlation computation tasks from the task list to remote recommendation devices,
receiving first content item set correlation data for a first set of content items from a remote recommendation device assigned a content item correlation computation task for the first set, and
including the first content item set correlation data in the correlation data store; and
and the remote recommendation device performs the steps of:
receiving content item set correlation data from the central recommendation server,
generating a content item recommendation in response to the content item set correlation data,
executing an assigned content item correlation computation task to generate associated content item set correlation data, and
transmitting the associated content item set correlation data to the central recommendation server.
